(19) United States
(12) Patent Application Publication
(10) Pub. No.: US 2026/0192287 A1
(43) Pub. Date: Jul. 9, 2026

(54) ACTIVE ACIDIC METALLIC POROUS COMPOSITE FOR THE EFFECTIVE DEOXYGENATION & AROMATIZATION OF BIO-CRUDE OIL UNDER METHANE ENVIRONMENT

(71) Applicant: Kara Technologies Inc., Calgary (CA)

(72) Inventors: Hua Song, Calgary (CA); Jack Jarvis, Calgary (CA); Zhaofei Li, Calgary (CA)

(21) Appl. No.: 19/556,080

(22) Filed: Mar. 4, 2026

Related U.S. Application Data
(63) Continuation of application No. PCT/IB2024/058658, filed on Sep. 5, 2024.
(60) Provisional application No. 63/581,301, filed on Sep. 8, 2023.

(51) Int. Cl. B01J 29/22; B01J 37/02; C10G 11/10

(52) U.S. Cl. CPC B01J 29/22; B01J 37/0201; C10G 11/10; C10G 2300/70

(57) ABSTRACT

A catalyst structure including a highly active, acidic, metal loaded and porous aluminosilicate (ZSM-5) is provided for the effective upgrading of bio-derived feedstocks such as aromatization and deoxygenation.

### CROSS-REFERENCE TO RELATED APPLICATION

This application is a continuation of International Patent Application No. PCT/IB2024/058658, filed Sep. 5, 2024, which claims priority from U.S. Provisional Patent Application Ser. No. 63/581,301, filed Sep. 8, 2023, the disclosures of which are incorporated herein by reference in their entirety.

### FIELD

The invention relates to the biofuel natural gas industry.

### BACKGROUND

In recent years, there has been a continuous growth in the demand for highly valuable chemicals such as high-octane value BTEX and other aromatics as chemical precursors. The major route to such chemicals is through the catalytic reforming of naphtha feedstocks which originate from the petrochemical refining industry. However, environmental and economic pressure has resulted in a shift from fossil fuels toward alternative and renewable sources such as bio-crude (the liquid product of biomass flash pyrolysis and even cooking oil). However, this bio-crude cannot be directly used as a fuel for spark engines due to its poor operational characteristics, arising mainly from oxygen content. Hence, bio-crude requires further treatment to make its components more desirable as chemical feedstocks and fuels. Current techniques suffer from many drawbacks such as low selectivity, high coke formation, and thus, catalyst deactivation issues. It has therefore become of great industrial importance to improve current techniques.

In the process of catalytic cracking, zeolites are traditionally used as heterogeneous catalysts and reaction promoters. In fact, they are one of, if not the most widely used, materials used in the conversion of hydrocarbons. One of the most well-known heterogeneous catalysts for petrochemical cracking and refinement is a microporous MFI structure aluminosilicate, H-ZSM5. H-ZSM5 has been reported to increase the octane number in refined products, with various researchers taking advantage of its cracking ability and selectivity. In addition, these properties can be effectively tuned by varying the levels of acidity of the zeolite through the alteration of silica to alumina ratios. Thermal stability and the ability to load metal promoters to further increase catalyst effectiveness has also been widely studied.

Hydrodeoxygenation (HDO) is frequently employed using a pure hydrogen mixture or a methanol co-feed as a hydrogen source. The reason for this is to assist with breaking any unsaturated bonds and to provide the hydrogen needed for reduction and hydrogenation steps. The use of hydrogen is expensive and dangerous, and methanol greatly increases energy consumption as a 2^{nd} liquid feed.

### SUMMARY

In accordance with embodiments described herein, a catalyst structure comprises an aluminosilicate zeolite porous support loaded with a plurality of metals and having a molar ratio composition as follows:

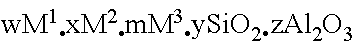

wherein:
w is between 0 and 9.23×10⁻²,
x is between 0 and 3.09×10⁻²,
m is between 0 and 3.09×10⁻²,
at least two of w, x and m are greater than 0,
y is between 9.50×10⁻¹ and 1,
z is between 2.84×10⁻³ and 4.36×10⁻², and
each of M¹, M² and M³ is, separate and independent of one another, a lanthanide, a transition element, or an element from Group 13 of the Periodic Table.

In another example embodiment, a catalyst structure comprises an aluminosilicate zeolite porous support loaded with a plurality of metals, the plurality of metals comprising at least two of a lanthanide, a transition element and an element from Group 13 of the Periodic Table, where:
the lanthanide is selected from the group consisting of lanthanum, cerium, praseodymium, neodymium, promethium, samarium, europium, gadolinium, terbium, dysprosium, holmium, erbium, thulium, ytterbium, and lutetium;
the transition element is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury;
the element from Group 13 of the Periodic Table selected from the group consisting of boron, aluminum, gallium, indium, and thallium;
each metal within the catalyst structure ranges from about 0.1% to about 10% by weight of the catalyst structure;
each lanthanide provided within the porous support is greater than 1% by weight of the catalyst structure; and
each Group 13 element provided within the porous support is less than 1% by weight of the catalyst structure.

Catalyst structures formed according to embodiments described herein can be used to upgrade a hydrocarbon feedstock to form a fuel product (e.g., a biofuel). For example, in accordance with embodiments described herein, a method comprises reacting a hydrocarbon feedstock in the presence of a catalyst structure as described herein and under a nitrogen, methane and/or hydrogen environment to form a biofuel product, where the biofuel product comprises liquid in an amount greater than 50% by weight of the fuel product and one or more aromatic hydrocarbons in an amount greater than 50% by weight of the fuel product.

The above and still further features and advantages of the present invention will become apparent upon consideration of the following detailed description of specific embodiments thereof.

### BRIEF DESCRIPTION OF THE DRAWINGS

FIG. 1 is a plot showing XRD patterns of ZSM-5 catalyst supports synthesized under Ar environment (A), air environment (B), and CH₄ environment (C). All three diffraction patterns are indicative of ZSM-5.

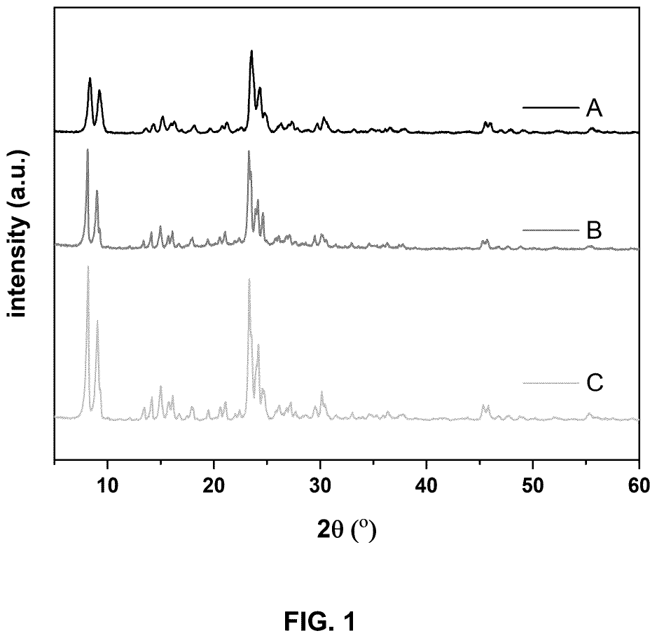

FIG. 2 is a plot showing nitrogen physisorption data for a support synthesized under air (A), loaded with 3× metal species using a citric acid method (B), and post reaction (C).

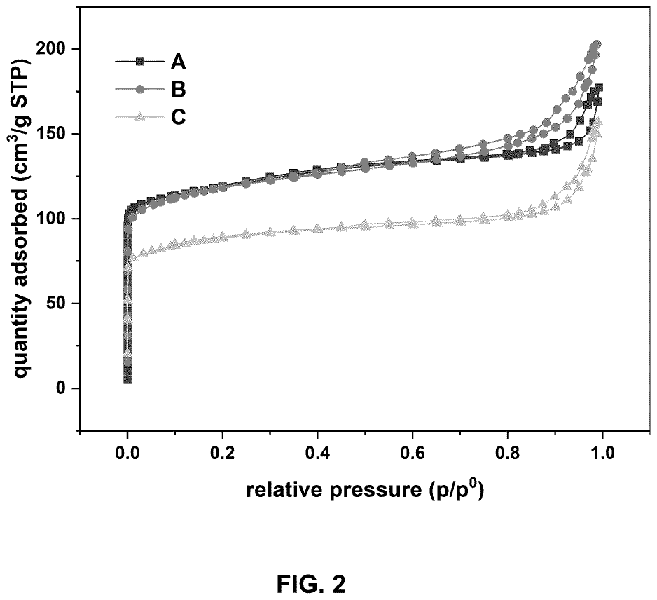

FIG. 3 is a plot showing nitrogen physisorption data for a support synthesized under CH₄ (A), loaded with 3× metal species using a citric acid method (B), and post reaction (C).

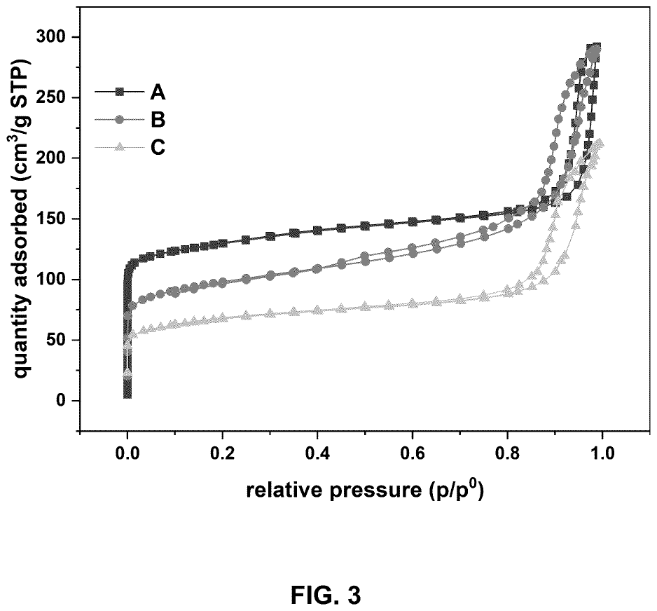

### DETAILED DESCRIPTION

In accordance with embodiments described herein, a catalyst structure facilitates the conversion or upgrading of a biomass, a bio-crude oil or other hydrocarbon feedstock into a product comprising non-oxygen containing aromatic compounds. Upgrading of a hydrocarbon such as a bio-crude oil, as described herein, refers to conversion of the feedstock into a biofuel product having a change in one or more physical properties and/or composition. Some non-limiting examples of upgrading (i.e., change from hydrocarbon feedstock to final upgraded product) include change (e.g., decrease) in density, change (e.g., decrease) in viscosity, change (e.g., decrease) in sulfur content, change (e.g., decrease) in TAN (total acid number), change (e.g., decrease) in an amount (e.g., weight percentage) of olefins, change (e.g., decrease) in an amount (e.g., weight percentage) of nitrogen, change (e.g., increase) in an amount (e.g., weight percentage) of one or more aromatic hydrocarbons, change (e.g., increase) in the hydrogen to carbon ratio (H/C ratio), and change (e.g., increase) in cetane number.

In particular, catalyst structures and methods of processing (upgrading) of hydrocarbon feedstock are directed toward the biofuel natural gas industry, more specifically, the upgrading of bio-crude oil and methane to highly valuable aromatics over a highly active, acidic, monometallic and/or bimetallic and/or trimetallic, and porous catalyst at moderate temperatures and pressures. The catalyst structures can be zeolite based and which are applicable in varying reactor systems. Methods of producing such catalyst structures are also described herein.

A heterogeneous catalyst is utilized in the reaction, synthesized in a unique environment which promotes the following features: pore size and distribution, metal valence (e.g., the metal species exist in one or multiple different combinations of their varying valences), memory effect, and activity.

In addition, in the present invention, methane is used as a hydrogen source, a cheap and less energy-intense hydrogen source. Methane is the main component in natural gas, a naturally occurring resource whose utilization is under-used due to the efforts needed to activate it. The use of methane or natural gas as a hydrogen donor for bio-crude deoxygenation is highly beneficial to the biofuel and natural gas industries.

The present invention further describes the deoxygenation of bio-crude under a methane environment as well as synthesizing a catalyst support.

Various embodiments of the invention include but are not limited to the synthesis of an acidic, mono/bi/tri metallic, porous catalyst for the purpose of converting bio-crude, including but not limited to, waste cooking oil, biomass flash pyrolysis product, and vegetable oils to non-oxygen-containing aromatics.

In example embodiments, a catalyst structure includes a porous support comprising a crystalline aluminosilicate zeolite. In particular, the porous support can comprise SiO₂ and Al₂O₃ that form one or more of the following structures: Zeolite Y, Zeolite Beta, Mordenite, ZSM-5, and Ferrierite. The SiO₂ to Al₂O₃ molar ratio for such porous supports can be in the range of 23-350.

The synthesis environment of the support can include one or all of the following gas environments as well as mixtures thereof: N₂, air, O₂, Ar, CH₄, and He.

The catalyst structure further includes one, two, or three metal promoters (e.g., metals in elemental or compound form) including lanthanides, transitions, and elements from Groups 13 and/or 14 of the periodic table, in which the amount of each metal within the catalyst structure can range from about 0.1% to about 10% by weight of the catalyst structure (i.e., the weight of the catalyst structure is the total or combined weight of the porous support and each metal promoter loaded within the porous support). In example embodiments, each lanthanide provided within the porous support is greater than 1% by weight of the catalyst structure, or at least 3% by weight of the catalyst structure. In further example embodiments, each transition element, each Group 13 element, and each Group 14 element within the porous support is less than 1% by weight of the catalyst structure. In still further embodiments, each lanthanide and transition element within the porous support is greater than 1% by weight of the catalyst structure while each Group 13 element and each Group 14 element within the porous support is less than 1% by weight of the catalyst structure.

In further embodiments herein, bio-crude can further be processed in the presence of carrier gases comprising one or more of CH₄, N₂ and H₂ (e.g., as either independent co-feeds with biocrude or combinations of the aforementioned gases as co-feeds with varying biocrude feeds).

Reactor systems used to process bio-crude can comprise one or more of a batch reactor system, a continuous stirred-tank reactor (CSTR), a continuous tubular reactor (CTR), a semi batch reactor, and varying catalytic reactors including, without limitation, fixed bed, trickle-bed, moving bed, rotating bed, fluidized bed, as well as slurry reactors.

Different combinations of temperatures and pressures ranging from 250-800° C. and 1-200 atm can be employed in the reactor systems for processing bio-crude.

Catalysts as described herein can be used for processing bio-crude that reduces coke yields to less than 5% by total weight of the yielded product.

The catalysts as described herein, when utilized in processing of bio-crude according to methods described herein, further provide selectivity toward aromatics, CO, and CO₂ in an amount greater than 75% by weight of the yielded product under conditions as described herein with yields greater than 65% by weight of the yielded product and deoxygenation greater than 90%. By weight of the yielded product.

In the methods described herein, reactants to catalyst weight ratios can be between 10:1 and 1:10.

A porous, acidic, supported metal catalyst is synthesized as described herein using wetness impregnation (WI) or incipient wetness impregnation (IWI) techniques.

Porous ZSM-5 can be suitably prepared by preparation of an aqueous solution of an organic template such as tetrapropylammonium hydroxide (TPAOH) to obtain 1 mol/L, followed by stirring and the addition of a suitable amount of alumina precursor such as a sulfate, a nitrate and/or a chloride. As an alternative to TPAOH, other organic templates useful for preparing porous ZSM-5 include, without limitation, tetramethylammonium hydroxide (TMAOH) and tetraethylammonium hydroxide (TEAOH).

The initial hydrolysis of an organic silica source, such as fused silica and/or tetraethyl orthosilicate (TEOS) is achieved by addition of varying amounts of organic template to an amount of silica source to obtain a predetermined SiO₂/Al₂O₃ molar ratio, thus in line with the above amount of alumina salt used, ranging from 23:1 to 350:1. After a given amount of time ranging from 1-60 minutes the silica source solution is added to the organic template aqueous solution containing alumina salt at room temperature (RT, e.g., about 20-22° C.). A supersaturated solution is obtained, e.g., within 5-2400 minutes, after complete addition of silica source solution and heating at 80° C., followed by crystallization shortly thereafter.

The crystalline material can then be hydrothermally synthesized at 120-200° C. for any time between 0.5-90 days to obtain a high purity crystalline powder, granules, aggregates, and/or molded product with particle sizes ranging from 5-500 nm. The hydrothermal synthesis can be performed in an autoclave that is pressurized with air, N₂, O₂, Ar, CH₄, and/or He or a mixture of, at pressures ranging from 1-50 atm.

If still in solution, the material can be freeze-dried. The material is then dried for an extensive period of time (3-24 hours) at temperatures above 75° C. and below 125° C. Post drying, the foregoing product is subjected to calcination under air, nitrogen or other gas dependent on the conditions desired for experimental use to promote crystallization and thermal stability. The crystal size as well as composition of the resulting product will vary depending on the ratios of the reaction mixtures employed.

The resulting catalyst support material requires metal loading to achieve desirable selectivity's and yield. Various known techniques can be employed to achieve such metal loading including, without limitation, incipient wetness impregnation (IWI), wetness impregnation (WI), hydrothermal (inclusion of metal into framework), galvanic replacement (GR), deposition precipitation (DP), and physical mixing. Any one or more of these techniques can be utilized to obtain desired amounts of metal loading.

In example embodiments, formation of the catalyst structure would include contacting the catalyst support material with a precursor salt of the desired metal, where the precursor salt can include, without limitation, nitrates, sulfates, chlorides, and combinations thereof. Citric acid may also be used to assist with dispersion during the above techniques.

In accordance with embodiments of the invention, metals loaded into the catalyst support material to form the catalyst structure include one or more active metal species (lanthanides, transitions, and elements from Groups 13 and 14 of the periodic table) and/or a combination of the aforementioned to obtain a metal alloy. Metal loadings calculated by weight range between 0.1-10% by weight of the catalyst structure of both individual metals and/or a combination of the two to obtain a bimetallic catalyst and/or a combination of three to obtain a trimetallic catalyst.

In example embodiments, the catalyst structure formed as described herein comprises a crystalline, metal loaded, aluminosilicate zeolite having a molar ratio composition as follows:

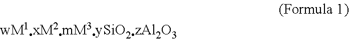

where:
w is between 0 and 9.23×10⁻²,
x is between 0 and 3.09×10⁻²,
m is between 0 and 3.09×10⁻²,
at least two of w, x and m are greater than 0,
y is between 9.50×10⁻¹ and 1,
z is between 2.84×10⁻³ and 4.36×10⁻², and
each of M¹, M² and M³ is, separate and independent of one another, a lanthanide, a transition element, or an element from Group 13 of the Periodic Table.

The lanthanides can include any one or more of lanthanum, cerium, praseodymium, neodymium, promethium, samarium, europium, gadolinium, terbium, dysprosium, holmium, erbium, thulium, ytterbium, and lutetium.

The transition element can include any one or more of the elements of Groups 3-12 of the Periodic Table, some examples of which include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury.

Elements from Group 13 of the Periodic Table can include boron, aluminum, gallium, indium, thallium, and ununtrium. Elements from Group 14 of the Periodic Table can include carbon, silicon, germanium, tin and lead.

In example embodiments described herein, the catalyst structures formed including a catalyst support material comprising an aluminosilicate zeolite loaded with any combination of two or more metals selected from the group consisting of cerium (Ce), gallium (Ga) and platinum (Pt), such as a combination of Ce, Ga and Pt, or a combination of Ce and Ga, or a combination of Ce and Pt, or a combination of Ga and Pt, where the metals are provided in molar amounts within the catalyst structure that satisfy the Formula 1 as described herein. Some specific and non-limiting examples (as demonstrated in Examples 1-10 provided herein) of catalyst structures with certain molar ratios of metals and porous support are as follows:
2.22×10⁻² Ce·4.49×10⁻³ Ga·1.60×10⁻³ Pt·9.59×10⁻¹ SiO₂·1.22×10⁻² Al₂O₃;
2.23×10⁻² Ce·1.6×10⁻³ Pt·9.64×10⁻¹ SiO₂·1.23×10⁻² Al₂O₃;
2.23×10⁻² Ce·4.48×10⁻³ Ga·9.61×10⁻¹ SiO₂·1.23×10⁻² Al₂O₃; and
1.56×10⁻³ Pt·4.35×10⁻³ Ga·9.82×10⁻¹ SiO₂·1.25×10⁻² Al₂O₃.

Some further non-limiting examples of catalyst structures with metals loaded in the porous support and at certain weight percentage (wt %) amounts (based upon the weight of the catalyst structure, i.e., combined weight of metals and porous support) are as follows:
5 wt % Ce, 0.5 wt % Ga, and 0.5 wt % Pt;
5 wt % Ce and 0.5 wt % Pt;
5 wt % Ce and 0.5 wt % Ga;
0.5 wt % Pt and 0.5 wt % Ga; and
3 wt % La, 3 wt % Cu, and 0.6 wt % In.

The resulting combination of metals loaded catalyst are dried at a temperature above 75° C. and below 150° C. for a period of time between 1 hour and 24 hours, followed by subjecting the structure to calcination under air, nitrogen or another gas at a predetermined temperature (300-700° C.) and ramp rate (1-20° C./min) depending upon desired reaction conditions.

The resultant catalyst structure having the Formula 1 can be employed for a range of catalytic cracking, hydrocracking, methane cracking, and deoxygenation (the activation of methane for inclusion of C and H atoms into the reactions and products) of hydrocarbon feedstock such as bio-crude or biofuels. Bio-crude oil or biofuel can be formed from liquefaction of biomass (e.g., wood, algae, organic solid municipal or agricultural waste, etc.). In other example embodiments, the catalyst structure having the Formula 1 can be used for aromatization and deoxygenation of a bio-crude oil (e.g., waste cooking oil), a biomass flash pyrolysis product, or organic liquids such as vegetable oils (e.g., converting a vegetable oil into a biofuel oil). Selectivity toward certain aromatics and/or other products can be tuned using different reactor systems, temperatures, and pressures. The hydrocarbon feedstock to catalyst ratio in the reaction can be from 10:1 and 1:10.

In the reaction process of converting biomass, bio-crude oil or other organic liquid or liquid hydrocarbon feedstock into an upgraded biofuel product using the catalyst structure as described herein, reactions can be performed in the presence of one or more of nitrogen, hydrogen, methane and/or other gases, where any one or combination of such gases can be combined with the biomass, bio-crude and/or other hydrocarbon feedstock to the reactor which includes the catalyst structure. The gas or gases can be fed simultaneously with, before or after the hydrogen feedstock is provided within the reactor, where the initiation of the one or more gases into the reactor can also be controlled based upon achieving a desired temperature within the reactor.

Reaction temperatures in which the gas or gases are combined with hydrocarbon feedstock and exposed to the catalyst structure having the Formula 1 can range between 200-800° C., preferably between 300° C. and 500° C. with pressures ranging between 1-200 atm, preferably between 1-80 atm. As previously noted herein, any one or combination of reactor systems can be utilized to upgrade a biomass, bio-crude or any other hydrocarbon feedstock utilizing the catalyst structure as described herein, including without limitation, one or more of a batch reactor system, a continuous stirred-tank reactor (CSTR), a continuous tubular reactor (CTR), and a semi batch reactor. Further, varying types of catalytic reactors can be used including, without limitation, one or more of a fixed bed, a trickle-bed, a moving bed, a rotating bed, fluidized bed, and a slurry reactor.

Some examples of catalyst structures formed herein and having the Formula 1 are now described along with performance of such catalyst structures in the upgrading of a bio-crude feedstock.

### Example 1

5 wt % Ce-0.5 wt % Ga-0.5 wt % Pt/HZSM-5-CH₄ catalyst was prepared in the following manner.

HZSM-5-CH₄ in powder form was synthesized using fumed silica, Al(NO₃)₃·9H₂O, TPAOH, and DI water. 1 mol/L TPAOH was mixed with 8.33×10⁻¹ gAl(NO₃)₃·9H₂O to form a clear solution. 9.20 g of fumed silica was added and stirred for 1 hour under room temperature (about 20° C.). This solution was then dried at 80° C. until suitable amount of water remained. This was then ground into a powder, transferred to a 200 mL autoclave and the atmosphere purged with methane. Once purged, the autoclave was filled to 30 bar pressure with methane. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 hours until dry. The sample was then calcined in a muffle furnace at 500° C. with a ramping rate of 0.5° C./min. The resulting catalyst was then washed with centrifugation ×3 and was ready for use. This resulted in a catalyst structure having a molar composition of 2.22×10⁻² Ce·4.49×10⁻³ Ga·1.60×10⁻³ Pt·9.59×10⁻¹ SiO₂·1.22×10⁻² Al₂O₃.

Bio-crude oil (0.9 g) was added to a 100 mL batch reactor (100 mL) loaded with 0.3 g of the catalyst structure formed as described by Example 1. The reaction was carried out for 40 minutes at 400° C. and 30 bar initial CH₄/N₂ (90%/10% by mol) after ramping at 20° C./min. The bio-crude oil was upgraded to a biofuel product having features as described herein with reference to Tables 1-4.

### Example 2

5 wt % Ce-0.5 wt % Ga-0.5 wt % Pt/HZSM-5-air catalyst was prepared in the following manner.

HZSM-5-air in powder form was synthesized using fumed silica, Al(NO₃)₃·9H₂O, TPAOH, and DI water. 1 mol/L TPAOH was mixed with 8.33×10⁻¹ g Al(NO₃)₃·9H₂O to form a clear solution. 9.20 g of fumed silica was added and stirred for 1 hour under room temperature. This solution was then dried at 80° C. until suitable amount of water remained. This was then ground into a powder, transferred to a 200 mL autoclave and the atmosphere purged with air. Once purged, the autoclave was filled to 30 bar pressure with methane. The sample was then crystallized by heating to 170° C. in the methane-filled autoclave for 24 hours. Support was then washed 3× using centrifugation. The final step for support preparation required calcining at 550° C. for 3 h to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The specific pore volume (ml/g) of the support prepared earlier (HZSM-5-CH₄) was measured first and the metal salts solution were evaporated to meet the pore volume of the support material. Following that, the support was added to the solution with mild agitation for half an hour and set in the ambient conditions for 2 h before drying at 80° C. for 6 hours. The sample was then calcined in a muffle furnace at 500° C. with a ramping rate of 0.5° C./min. The catalyst was collected and was ready for use. This resulted in a molar composition of 2.22×10⁻² Ce·4.49×10⁻³ Ga·1.60×10⁻³ Pt·9.59×10⁻¹ SiO₂. 1.22×10⁻² Al₂O₃.

Biocrude (0.9 g) was added to a 100 mL batch reactor (100 mL) loaded with 0.3 g of catalyst. The reaction was carried out for 40 minutes at 400° C. and 30 bar initial CH₄/N₂ (90%/10% by mol) after ramping at 20° C./min. The bio-crude oil was upgraded to a biofuel product having features as described herein with reference to Tables 1-4.

### Example 3

5 wt % Ce-0.5 wt % Ga-0.5 wt % Pt/HZSM-5-CH₄ catalyst was prepared in the following manner.

HZSM-5-CH₄ in powder form was synthesized using fumed silica, Al(NO₃)₃·9H₂O, TPAOH, and DI water. 1 mol/L TPAOH was mixed with 8.33×10⁻¹ gAl(NO₃)₃·9H₂O to form a clear solution. 9.20 g of fumed silica was added and stirred for 1 hour under room temperature. This solution was then dried at 80° C. until suitable amount of water remained. This was then ground into a powder, transferred to a 200 mL autoclave and the atmosphere purged with methane. Once purged, the autoclave was filled to 30 bar pressure with methane. The sample was then crystallized by heating to 170° C. in the methane-filled autoclave for 24 h. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 hours until dry. The sample was then calcined in a muffle furnace at 500° C. with a ramping rate of 0.5° C./min. The resulting catalyst was then washed with centrifugation ×3 and was ready for use. This resulted in a molar composition of 2.22×10⁻²Ce.4.49×10⁻³Ga·1.60×10⁻³Pt·9.59×10⁻¹SiO₂·1.22×10⁻²Al₂O₃.

Biocrude (0.9 g) was added to a 100 mL batch reactor (100 mL) loaded with 0.3 g of catalyst. The reaction was carried out for 40 minutes at 400° C. and 30 bar initial N₂ after ramping at 20° C./min. The bio-crude oil was upgraded to a biofuel product having features as described herein with reference to Tables 1-4.

### Example 4

5 wt % Ce-0.5 wt % Ga-0.5 wt % Pt/HZSM-5-air catalyst was prepared in the following manner.

HZSM-5-air in powder form was synthesized using fumed silica, Al(NO₃)₃·9H₂O, TPAOH, and DI water. 1 mol/L TPAOH was mixed with 8.33×10⁻¹ g Al(NO₃)₃·9H₂O to form a clear solution. 9.20 g of fumed silica was added and stirred for 1 h under room temperature. This solution was then dried at 80° C. until suitable amount of water remained. This was then ground into a powder, transferred to a 200 mL autoclave and the atmosphere purged with air. Once purged, the autoclave was filled to 30 bar pressure with methane. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 h until dry. The sample was then calcined in a muffle furnace at 500° C. with a ramping rate of 0.5° C./min. The resulting catalyst was then washed with centrifugation ×3 and was ready for use. This resulted in a molar composition of 2.22×10⁻²Ce·4.49×10⁻³Ga·1.60×10⁻³Pt·9.59×10⁻¹ SiO₂·1.22×10⁻² Al₂O₃.

Biocrude (0.9 g) was added to a 100 mL batch reactor (100 mL) loaded with 0.3 g of catalyst. The reaction was carried out for 40 minutes at 400° C. and 30 bar initial N₂ after ramping at 20° C./min. The bio-crude oil was upgraded to a biofuel product having features as described herein with reference to Tables 1-4.

### Example 5

5 wt % Ce-0.5 wt % Pt/HZSM-5-CH₄ catalyst was prepared in the following manner.

HZSM-5-CH₄ in powder form was synthesized using fumed silica, Al(NO₃)₃·9H₂O, TPAOH, and DI water. 1 mol/L TPAOH was mixed with 8.38×10⁻¹ g Al(NO₃)₃·9H₂O to form a clear solution. 9.25 g of fumed silica was added and stirred for 1 hour under room temperature. This solution was then dried at 80° C. until suitable amount of water remained. This was then ground into a powder and transferred to a 200 mL autoclave. The autoclave was filled to 30 bar pressure with CH₄. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.10 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 hours until dry. The sample was then calcined in a muffle furnace at 500° C. with a ramping rate of 0.5° C./min. The resulting catalyst was then washed with centrifugation ×3 and was ready for use. This resulted in a molar composition of 2.23×10⁻² Ce·1.6×10⁻³ Pt·9.64×10⁻¹ SiO₂·1.23×10⁻² Al₂O₃.

Biocrude (0.9 g) was added to a 100 mL batch reactor (100 mL) loaded with 0.3 g of catalyst. The reaction was carried out for 40 minutes at 400° C. and 30 bar initial CH₄/N₂ (90%/10% by mol) after ramping at 20° C./min. The bio-crude oil was upgraded to a biofuel product having features as described herein with reference to Tables 1-4.

### Example 6

5 wt % Ce-0.5 wt % Ga/HZSM-5-CH₄ catalyst was prepared in the following manner.

HZSM-5-CH₄ in powder form was synthesized using fumed silica, Al(NO₃)₃·9H₂O, TPAOH, and DI water. 1 mol/L TPAOH was mixed with 8.38×10⁻¹ g Al(NO₃)₃·9H₂O to form a clear solution. 9.25 g of fumed silica was added and stirred for 1 h under RT. This solution was then dried at 80° C. until suitable amount of water remained. This was then ground into a powder and transferred to a 200 mL autoclave. The autoclave was filled to 30 bar pressure with CH₄. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), and 1.24 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 h until dry. The sample was then calcined in a muffle furnace at 500° C. with a ramping rate of 0.5° C./min. The resulting catalyst was then washed with centrifugation ×3 and was ready for use. This resulted in a molar composition of 2.23×10⁻²Ce·4.48×10⁻³Ga·9.61×10⁻¹SiO₂·1.23×10⁻²Al₂O₃.

Biocrude (0.3 g) was added to a 100 mL batch reactor (100 mL) loaded with 3 g of catalyst. The reaction was carried out for 40 minutes at 200° C. and 30 bar initial CH₄/N₂ (90%/10% by mol) after ramping at 20° C./min. The bio-crude oil was upgraded to a biofuel product having features as described herein with reference to Tables 1-4.

### Example 7

0.5 wt % Pt-0.5 wt % Ga/HZSM-5-CH₄ catalyst was prepared in the following manner: HZSM-5-CH₄ in powder form was synthesized using fumed silica, Al(NO₃)₃·9H₂O, TPAOH, and DI water. 1 mol/L TPAOH was mixed with 8.77×10⁻¹ g Al(NO₃)₃·9H₂O to form a clear solution. 9.69 g of fumed silica was added and stirred for 1 h under RT. This solution was then dried at 80° C. until suitable amount of water remained. This was then ground into a powder and transferred to a 200 mL autoclave. The autoclave was filled to 30 bar pressure with CH₄. The sample was then crystallized by heating to 170° C. in the methane-filled autoclave for 24 h. Support was then washed 3× using centrifugation. The final step for support preparation required calcining at 550° C. for 3 h to remove any template. Metal salts of 1.96×10⁻¹ g gallium(III) nitrate hydrate (Ga(NO₃)₃·xH₂O), 9.92×10⁻² g tetraammineplatinum(II) nitrate ([Pt(NH₃)₄](NO₃)₂), and 0.28 g of citric acid powder were added to a DI water solution and stirred until completely dissolved. The support prepared earlier (HZSM-5-CH₄) was added to the solution and mixed at 80° C. for 3 h. The water was then centrifuged out and the remaining wet powder left in an oven at 80° C. for 6 h until dry. The sample was then calcined in a muffle furnace at 500° C. with a ramping rate of 0.5° C./min. The resulting catalyst was then washed with centrifugation ×3 and was ready for use. This resulted in a molar composition of 1.56×10⁻³Pt·4.35×10⁻³Ga·9.82×10⁻¹SiO₂·1.25×10⁻²Al₂O₃.

Biocrude (0.9 g) was added to a 100 mL batch reactor (100 mL) loaded with 0.1 g of catalyst. The reaction was carried out for 40 minutes at 450° C. and 40 bar initial CH₄/N₂ (90%/10% by mol) after ramping at 20° C./min. The bio-crude oil was upgraded to a biofuel product having features as described herein with reference to Tables 1-4.

### Example 8

3 wt % La-3 wt % Cu-0.6 wt % In/HZSM-5-CH₄ catalyst was prepared in the following manner: HZSM-5-CH₄ in powder form was synthesized using fumed silica, Al(NO₃)₃·9H₂O, TPAOH, and DI water. 1 mol/L TPAOH was mixed with 0.0573 g Al(NO₃)₃·9H₂O to form a clear solution. 9.69 g of fumed silica was added and stirred for 1 h under RT. This solution was then dried at 80° C. until suitable amount of water remained. This was then ground into a powder and transferred to a 300 mL autoclave. The autoclave was filled to 30 bar pressure with CH₄. The sample was then crystallized by heating to 200° C. in the methane-filled autoclave for 12 h. Support was then washed 3× using centrifugation. The final step for support preparation required calcining at 550° C. for 3 h to remove any template. Metal salts of 1.49 g La(NO₃)₃·6H₂O, 2.31×10⁻¹ g Indium (III) nitrate hydrate (In(NO₃)₃·xH₂O), 8.63×10⁻¹ g copper (II) nitrate Cu(NO₃)₂, and 1.5 g of citric acid powder were added to a DI water solution and stirred until completely dissolved. The support prepared earlier (HZSM-5-CH₄) was added to the solution and mixed at 80° C. for 3 h. The water was then centrifuged out and the remaining wet powder left in an oven at 80° C. for 6 h until dry. The sample was then calcined in a muffle furnace at 500° C. with a ramping rate of 0.5° C./min. The resulting catalyst was then washed with centrifugation ×3 and was ready for use. This resulted in the 3 wt % La-3 wt % Cu-0.6 wt % In/HZSM-5-CH₄ catalyst while with a high silica to alumina ratio of 350.

Biocrude upgrading was performed with a commercial high-pressure Microactivity Effi fixed reactor from Micromeritics. 0.5 g of catalyst was loaded into the reactor and the biocrude was pumped into the reactor with the space velocity of 2 h⁻¹. Meanwhile, a 30 bar CH₄/N₂ (90%/10% by mol) gas was introduced into the reactor system and reaction was kept at 400° C. for 1 hour before cooling down. The reaction performances as described herein with reference to Tables 1-4.

### Example 9

5 wt % Ce-0.5 wt % Ga-0.5 wt % Pt/HZSM-5-CH₄ catalyst (with a high silica to alumina ratio) was prepared in the following manner.

HZSM-5-CH₄ in powder form was synthesized using fumed silica, Al(NO₃)₃·9H₂O, TPAOH, and DI water. 1 mol/L TPAOH was mixed with 0.0573 gAl(NO₃)₃·9H₂O to form a clear solution. 9.20 g of fumed silica was added and stirred for 1 hour under room temperature (about 20° C.). This solution was then dried at 80° C. until suitable amount of water remained. This was then ground into a powder, transferred to a 200 mL autoclave and the atmosphere purged with methane. Once purged, the autoclave was filled to 30 bar pressure with methane. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 hours until dry. The sample was then calcined in a muffle furnace at 500° C. with a ramping rate of 0.5° C./min. The resulting catalyst was then washed with centrifugation ×3 and was ready for use. This resulted in a catalyst structure having a molar composition of 2.22×10⁻²Ce·4.49×10⁻³Ga·1.60×10⁻³Pt·9.59×10⁻¹SiO₂. 1.22×10⁻²Al₂O₃.

Bio-crude oil (0.9 g) was added to a 100 mL batch reactor (100 mL) loaded with 0.6 g of the catalyst structure formed as described by Example 1. The reaction was carried out for 60 minutes at 450° C. and 50 bar initial CH₄/N₂ (90%/10% by mol) after ramping at 20° C./min. The bio-crude oil was upgraded to a biofuel product having features as described herein with reference to Tables 1-4.

### Example 10

5 wt % Ce-0.5 wt % Ga-0.5 wt % Pt/HZSM-5-CH₄ catalyst (with a high silica to alumina ratio) was prepared in the following manner.

HZSM-5-CH₄ in powder form was synthesized using fumed silica, Al(NO₃)₃·9H₂O, TPAOH, and DI water. 1 mol/L TPAOH was mixed with 0.0573 gAl(NO₃)₃·9H₂O to form a clear solution. 9.20 g of fumed silica was added and stirred for 1 hour under room temperature (about 20° C.). This solution was then dried at 80° C. until suitable amount of water remained. This was then ground into a powder, transferred to a 200 mL autoclave and the atmosphere purged with methane. Once purged, the autoclave was filled to 30 bar pressure with methane. The sample was then crystallized by heating to 170° C. in the methane-filled autoclave for 24 hours. Support was then washed 3× using centrifugation. The final step for support preparation required calcining at 550° C. for 3 hours to remove any template.

Metal salts of 1.96×10⁻¹ g gallium(III) nitrate hydrate (Ga(NO₃)₃·xH₂O), 1.51 g cerium(III) nitrate hexahydrate (Ce(NO₃)₃·6H₂O), 9.92×10⁻² g tetraammineplatinum(II) nitrate ([Pt(NH₃)₄](NO₃)₂), and 1.31 g of citric acid powder were added to a DI water solution and stirred until completely dissolved. The support prepared earlier (HZSM-5-CH₄) was added to the solution and mixed at 80° C. for 3 hours. The water was then centrifuged out and the remaining wet powder left in an oven at 80° C. for 6 hours until dry. The sample was then calcined in a muffle furnace at 500° C. with a ramping rate of 0.5° C./min. The resulting catalyst was then washed with centrifugation ×3 and was ready for use. This resulted in a catalyst structure having a molar composition of 2.22×10⁻²Ce·4.49×10⁻³Ga·1.60×10⁻³Pt 9.59×10⁻¹SiO₂·1.22×10⁻²Al₂O₃.

Biocrude upgrading was performed with a commercial high-pressure Microactivity Effi fixed reactor from Micromeritics. 0.5 g of catalyst was loaded into the reactor and the biocrude was pumped into the reactor with the space velocity of 0.5 h⁻¹. Meanwhile, a 50 bar CH₄/N₂ (90%/10% by mol) gas was introduced into the reactor system and reaction was kept at 450° C. for 1 hour before cooling down. The reaction performances as described herein with reference to Tables 1-4.

Tables 1-4 show the overall analysis and mass balance for each of Examples 1-10, in which the bio-crude oil (oleic acid, an unsaturated fatty acid) was upgraded in the manner as described in the examples to form an upgraded biofuel product. The results for the examples show that liquid biofuel is the majority yield (greater than 50% by weight).

Table 1 presents data with regard to gas, liquid and solid yields for the biofuel product formed in Examples 1-10.

TABLE 1

| | gas yield | liquid yield | solid yield | mass balance |
|---|---|---|---|---|
| example | (wt %) | (wt %) | (wt %) | (wt %) |
| 1 | 40.9 | 57.0 | 2.8 | 100.7 |
| 2 | 40.5 | 57.0 | 3.2 | 100.7 |
| 3 | 36.5 | 56.6 | 6.1 | 99.2 |
| 4 | 37.1 | 57.5 | 4.7 | 99.3 |
| 5 | 40.0 | 57.9 | 2.6 | 100.5 |
| 6 | 41.6 | 57.0 | 2.3 | 100.9 |
| 7 | 39.3 | 58.7 | 3.2 | 101.2 |
| 8 | 31.5 | 60.6 | 7.4 | 99.5 |
| 9 | 35.7 | 61.0 | 3.5 | 100.2 |
| 10 | 34.3 | 64.8 | 1.3 | 100.4 |

Table 2 shows the methane (CH₄) conversion and deoxygenation of biofuel product for the examples described herein.

TABLE 2

| | CH₄ conversion | CO₂ | CO | other O* |
|---|---|---|---|---|
| example | (wt %) | (mmol) | (mmol) | (mmol) |
| 1 | 3.2 | 5.2 | 0.7 | 0.5 |
| 2 | 2.1 | 4.2 | 0.9 | 1.3 |
| 3 | — | 3.3 | 2.1 | 1 |
| 4 | — | 3 | 1.9 | 1.5 |
| 5 | 1.6 | 5.2 | 0.5 | 0.7 |
| 6 | 3 | 4.8 | 1.3 | 0.2 |
| 7 | 2.8 | 4.3 | 0.6 | 1.5 |
| 8 | 2.7 | 4.0 | 0.3 | 1.9 |
| 9 | 3.5 | 5.6 | 0.9 | 0.3 |
| 10 | 2.2 | 3.8 | 0.7 | 1.2 |

*includes H₂O and other oxygen containing species found in the liquid product

Table 3 shows liquid product selectivity for the examples described herein, including paraffins, polycyclic aromatic hydrocarbons (PAHs), aromatic, olefins, naphthenes and oxygenates.

TABLE 3

| | Paraffins | PAH | Aromatics | Olefins | naphthenes | Oxygenates* |
|---|---|---|---|---|---|---|
| Example | (wt %) | (wt %) | (wt %) | (wt %) | (wt %) | (wt %) |
| 1 | 4.1 | 1.8 | 89.1 | 1.6 | 1.5 | 1.8 |
| 2 | 6.3 | 4.6 | 78.3 | 4.1 | 1.1 | 5.6 |
| 3 | 5.1 | 8.8 | 70.7 | 8.6 | 2.9 | 3.9 |
| 4 | 3.6 | 9.8 | 68.9 | 8.8 | 3.4 | 5.5 |
| 5 | 8.8 | 2.7 | 81.0 | 2.1 | 3.1 | 2.3 |
| 6 | 10.6 | 2.6 | 76.4 | 1.1 | 6.5 | 2.8 |
| 7 | 10.9 | 3.3 | 77.1 | 1.5 | 4.9 | 2.3 |
| 8 | 8.9 | 3.4 | 69.5 | 1.2 | 4.3 | 3.0 |
| 9 | 3.8 | 2.8 | 86.1 | 2.6 | 2.4 | 1.7 |
| 10 | 7.4 | 2.5 | 63.5 | 1.0 | 3.7 | 3.4 |

*includes H₂O and other oxygen containing species found in the liquid product

Table 4 shows the gas product selectivity for the examples described herein.

TABLE 4

| | H₂ | ═C₂-C₅═ | —C₂-C₅— | CO | CO₂ |
|---|---|---|---|---|---|
| example | (wt %) | (wt %) | (wt %) | (wt %) | (wt %) |
| 1 | 0.6 | 16.3 | 46.8 | 5.3 | 31.0 |
| 2 | 0.4 | 26.8 | 43.0 | 7.2 | 22.6 |
| 3 | 0.4 | 34.6 | 22.0 | 17.8 | 22.0 |
| 4 | 0.3 | 33.8 | 27.0 | 16.1 | 19.7 |
| 5 | 0.4 | 22.6 | 41.3 | 5.1 | 30.6 |
| 6 | 0.3 | 12.8 | 48.2 | 10.0 | 28.7 |
| 7 | 0.4 | 26.7 | 41.7 | 4.7 | 26.5 |
| 8 | 0.5 | 25.1 | 52.3 | 4.0 | 27.2 |
| 9 | 0.8 | 18.6 | 44.1 | 4.8 | 34.1 |
| 10 | 0.4 | 19.3 | 47.9 | 3.3 | 24.1 |

Thus, the catalyst structures as described herein enable upgrading of a hydrocarbon feedstock, such as a biomass or bio-crude oil, to form a fuel product (e.g., biofuel product) in which a majority (greater than 50% by weight of the fuel product) is liquid and further a majority (50% or greater by weight of the fuel product) is one or more aromatic hydrocarbons. In addition, the hydrocarbon feedstock has been deoxygenated to a significant extent, where the upgraded fuel product contains less than 6% by weight of the fuel product of oxygenates or less than 10 mmol of oxygenates (where “oxygenates” refers to any oxygen containing compounds, including CO, CO₂, H₂O and any other oxygen containing compounds).

Accordingly, a catalyst structure as described herein can comprise an aluminosilicate zeolite porous support loaded with a plurality of metals and having a molar ratio composition as follows:

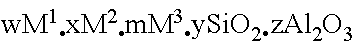

where:
w is between 0 and 9.23×10⁻²,
x is between 0 and 3.09×10⁻²,
m is between 0 and 3.09×10⁻²,
at least two of w, x and m are greater than 0,
y is between 9.50×10⁻¹ and 1,
z is between 2.84×10⁻³ and 4.36×10⁻², and
each of M¹, M² and M³ is, separate and independent of one another, a lanthanide, a transition element, or an element from Group 13 of the Periodic Table.

The zeolite porous support of the catalyst structure can be formed from a dry-gel treatment and thereafter metal loading treatment from one or all of the following treatments: IWI, WI, with framework inclusion.

The metal species can exist in one or multiple different combinations of their varying valences.

A ratio of SiO₂ to Al₂O₃ for the porous support can be between 23:1 and 350:1.

The catalyst structure can have the following molar composition:
2.22×10⁻²Ce·4.49×10⁻³Ga·1.60×10⁻³Pt·9.59×10⁻¹SiO₂·1.22×10⁻²Al₂O₃; or
2.23×10⁻²Ce·1.6×10⁻³Pt·9.64×10⁻¹SiO₂·1.23×10⁻²Al₂O₃; or
2.23×10⁻²Ce·4.48×10⁻³Ga·9.61×10⁻¹SiO₂·1.23×10⁻²Al₂O₃; or
1.56×10⁻³Pt·4.35×10⁻³Ga·9.82×10⁻¹SiO₂·1.25×10⁻²Al₂O₃.

In another embodiment, a method of preparing a catalyst structure as described herein can comprise preparing a mixture containing aqueous alumina precursor selected from one or more of TPAOH, TEAOH, TMAOH and TEOS and a silica precursor comprising sulfate, nitrate and/or chloride to form a zeolite support, and loading the zeolite support with one or more metals utilizing one or more of the following treatments: IWI, WI, with framework inclusion.

The method can be conducted under one or more gaseous environments selected from the group consisting of CH₄ N₂, and air.

The method can further comprise calcining the resultant material under air, nitrogen or another gas.

In another example embodiment, a method comprises reacting a hydrocarbon feedstock in the presence of a catalyst structure as described herein and under a nitrogen, methane and/or hydrogen environment to form a fuel product, where the fuel product comprises liquid in an amount greater than 50% by weight of the fuel product and one or more aromatic hydrocarbons in an amount greater than 50% by weight of the fuel product. The fuel product can also contain less than 6% by weight of the fuel product of oxygen containing compounds.

The reaction can occur within a reactor system comprising one or a combination of a batch reactor system and a fixed bed reactor.

The reaction conditions of the reaction can include reaction temperatures between 200° C. and 450° C. and/or reaction pressures between 1-50 atm.

The hydrocarbon feedstock to catalyst ratio can be from 10:1 and 1:10.

In a further example embodiment, a catalyst structure comprises an aluminosilicate zeolite loaded with a plurality of metals, the plurality of metals comprising at least two of a lanthanide, a transition element and an element from Group 13 of the Periodic Table, where:
the lanthanide is selected from the group consisting of lanthanum, cerium, praseodymium, neodymium, promethium, samarium, europium, gadolinium, terbium, dysprosium, holmium, erbium, thulium, ytterbium, and lutetium;
the transition element is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury;
the element from Group 13 of the Periodic Table selected from the group consisting of boron, aluminum, gallium, indium, and thallium;
each metal within the catalyst structure ranges from about 0.1% to about 10% by weight of the catalyst structure;
each lanthanide provided within the porous support is greater than 1% by weight of the catalyst structure; and
each Group 13 element provided within the porous support is less than 1% by weight of the catalyst structure.

The catalyst structure can include the following metals loaded in the porous support in a weight percentage (wt %) amount based upon the weight of the catalyst structure:
5 wt % Ce, 0.5 wt % Ga, and 0.5 wt % Pt; or
5 wt % Ce and 0.5 wt % Pt; or
5 wt % Ce and 0.5 wt % Ga; or
0.5 wt % Pt and 0.5 wt % Ga; or
3 wt % La, 3 wt % Cu, and 0.6 wt % In.

While the invention has been described in detail and with reference to specific embodiments thereof, it will be apparent to one skilled in the art that various changes and modifications can be made therein without departing from the spirit and scope thereof.

Thus, it is intended that the present invention covers the modifications and variations of this invention provided they come within the scope of the appended claims and their equivalents.

What is claimed:

1. A catalyst structure comprising an aluminosilicate zeolite porous support loaded with a plurality of metals and having a molar ratio composition as follows: 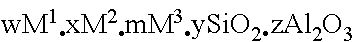
wherein:
w is between 0 and 9.23×10⁻²,
x is between 0 and 3.09×10⁻²,
m is between 0 and 3.09×10⁻²,
at least two of w, x and m are greater than 0,
y is between 9.50×10⁻¹ and 1,
z is between 2.84×10⁻³ and 4.36×10⁻², and
each of M¹, M² and M³ is, separate and independent of one another, a lanthanide, a transition element, or an element from Group 13 of the Periodic Table.

2. The catalyst structure of claim 1, wherein the aluminosilicate zeolite porous support is formed from a dry-gel treatment and thereafter metal loading treatment from one or all of the following treatments: IWI, WI, with framework inclusion.

3. The catalyst structure of claim 1, wherein the metal species exist in one or multiple different combinations of their varying valences.

4. The catalyst structure of claim 1, wherein a ratio of SiO₂ to Al₂O₃ of the aluminosilicate zeolite porous support is between 23:1 and 350:1.

5. The catalyst structure of claim 1, wherein the catalyst structure includes has the following molar composition:
2.22×10⁻²Ce·4.49×10⁻³Ga·1.60×10⁻³Pt·9.59×10⁻¹SiO₂·1.22×10⁻² Al₂O₃; or
2.23×10⁻²Ce·1.6×10⁻³Pt·9.64×10⁻¹SiO₂·1.23×10⁻²Al₂O₃; or
2.23×10⁻²Ce·4.48×10⁻³Ga·9.61×10⁻¹SiO₂·1.23×10⁻²Al₂O₃; or
1.56×10⁻³Pt·4.35×10⁻³Ga·9.82×10⁻¹SiO₂·1.25×10⁻²Al₂O₃.

6. A method of preparing a catalyst structure as recited in claim 1, the method comprising:
preparing a mixture containing aqueous alumina precursor selected from one or more of TPAOH, TEAOH, TMAOH and TEOS and a silica precursor comprising sulfate, nitrate and/or chloride to form a zeolite support; and
loading the zeolite support with one or more metals utilizing wetness impregnation (WI) or incipient wetness impregnation (IWI) to form a resultant material.

7. The method of claim 6, wherein the method is conducted under one or more gaseous environments selected from the group consisting of CH₄ N₂, and air.

8. The method of claim 6, further comprising calcining the resultant material under air, nitrogen or another gas.

9. A method comprising reacting a hydrocarbon feedstock in the presence of the catalyst structure of claim 1 and under a nitrogen, methane and/or hydrogen environment to form a fuel product, wherein the fuel product comprises liquid in an amount greater than 50% by weight of the fuel product and one or more aromatic hydrocarbons in an amount greater than 50% by weight of the fuel product.

10. The method of claim 9, wherein the fuel product contains less than 6% by weight of the fuel product of oxygen containing compounds.

11. The method of claim 9, wherein the reaction occurs within a reactor system comprising one or a combination of a batch reactor system and a fixed bed reactor.

12. The method of claim 9, wherein reaction conditions of the reaction include reaction temperatures between 200° C. and 450° C. and/or reaction pressures between 1-50 atm.

13. The method of claim 9, wherein hydrocarbon feedstock to catalyst ratio is from 10:1 and 1:10.

14. A catalyst structure comprising an aluminosilicate zeolite loaded with a plurality of metals, the plurality of metals comprising at least two of a lanthanide, a transition element and an element from Group 13 of the Periodic Table, wherein:
the lanthanide is selected from the group consisting of lanthanum, cerium, praseodymium, neodymium, promethium, samarium, europium, gadolinium, terbium, dysprosium, holmium, erbium, thulium, ytterbium, and lutetium;
the transition element is selected from the group consisting of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury;
the element from Group 13 of the Periodic Table selected from the group consisting of boron, aluminum, gallium, indium, and thallium;
each metal within the catalyst structure ranges from about 0.1% to about 10% by weight of the catalyst structure;
each lanthanide provided within the porous support is greater than 1% by weight of the catalyst structure; and
each Group 13 element provided within the porous support is less than 1% by weight of the catalyst structure.

15. The catalyst structure of claim 14, wherein the catalyst structure includes the following metals loaded in the porous support in a weight percentage (wt %) amount based upon the weight of the catalyst structure:
5 wt % Ce, 0.5 wt % Ga, and 0.5 wt % Pt; or
5 wt % Ce and 0.5 wt % Pt; or
5 wt % Ce and 0.5 wt % Ga; or
0.5 wt % Pt and 0.5 wt % Ga; or
3 wt % La, 3 wt % Cu, and 0.6 wt % In.
